(19) United States
(12) Patent Application Publication
(10) Pub. No.: US 2026/0121505 A1
(43) Pub. Date: Apr. 30, 2026

(54) CONTROL METHOD AND CONTROLLER FOR POWER SUPPLY CONVERSION CIRCUIT

(71) Applicant: LITE-ON ELECTRONICS (GUANGZHOU) LIMITED, GUANGZHOU (CN)

(72) Inventor: HUIFENG LIU, GUANGZHOU (CN)

(21) Appl. No.: 19/183,972

(22) Filed: Apr. 21, 2025

(30) Foreign Application Priority Data
Oct. 28, 2024 (CN) 202411520546.X

(51) Int. Cl. H02M 1/00; H02M 3/00

(52) U.S. Cl. CPC H02M 1/0012; H02M 1/0025; H02M 1/0035; H02M 3/01

(57) ABSTRACT

The application provides a power conversion circuit control method and a power conversion circuit controller. A first frequency is calculated based on an error value. A pulse width modulation (PWM) module is controlled to generate a switching signal based on the first frequency and a burst mode threshold frequency. A cycle count is generated based on whether the first frequency is higher than the burst mode threshold frequency. According to the cycle count and a predetermined cycle number, it is determined whether to transmit a command signal to the PWM module, and the PWM module, upon receiving the command signal, outputs one cycle of the switching signal.

### CROSS-REFERENCE TO RELATED APPLICATIONS

This application claims the benefit of China application Serial No. 202411520546.X, filed October 28, 2024, the disclosure of which is incorporated by reference herein in its entirety.

### TECHNICAL FIELD

The disclosure relates to a control method and a controller for a power supply conversion circuit.

### BACKGROUND

The LLC resonant power conversion circuit (a type of DC/DC power conversion circuit) has become a popular topic in the field of power electronics due to its ability to meet the stringent performance demands of modern power supply designs.

This type of switching-mode DC/DC power conversion circuit allows for higher switching frequencies and reduced switching losses, making it particularly suitable for high-power and high-efficiency applications. The LLC resonant power conversion circuit is an ideal choice for power applications requiring precision (such as high-end consumer electronics) or higher operating power (such as electric vehicle charging).

Currently, if the LLC resonant tank (also referred to as the LLC circuit) in an LLC resonant power conversion circuit does not employ burst mode or other measures, it can experience high circuit gain under light load, resulting in a very short soft start process with excessive current surges, which may lead to component specifications being exceeded.

Traditionally, the output voltage build-up time for an LLC circuit was typically between 2ms and 3ms to meet the specification requirements (greater than 2ms). However, recent industry expectations have shifted, with a preference for an output voltage build-up time greater than5ms or even over 20ms, which is challenging to achieve with current methods.

Therefore, the application introduces a new control method and controller for the power conversion circuit to meet the latest industry requirements.

### SUMMARY

According to one embodiment, a power conversion circuit control method is provided. The power conversion circuit controller comprises: a switching frequency calculation module, calculating a first frequency based on an error value; a pulse width modulation (PWM) module; a burst mode control module, coupled to the switching frequency calculation module and the PWM module, wherein the burst mode control module controls the PWM module to generate a switching signal based on the first frequency and a burst mode threshold frequency; and a switching cycle count module, coupled to the burst mode control module and the PWM module, wherein the switching cycle count module generates a cycle count based on whether the first frequency is higher than the burst mode threshold frequency, and according to the cycle count and a predetermined cycle number, the switching cycle count module determines whether to transmit a command signal to the PWM module, and the PWM module, upon receiving the command signal, outputs one cycle of the switching signal.

According to another embodiment, a power conversion circuit control method is provided. The power conversion circuit control method comprises: calculating a first frequency based on an error value; controlling a pulse width modulation (PWM) module to generate a switching signal based on the first frequency and a burst mode threshold frequency; generating a cycle count based on whether the first frequency is higher than the burst mode threshold frequency; and according to the cycle count and a predetermined cycle number, determining whether to transmit a command signal to the PWM module, and the PWM module, upon receiving the command signal, outputting one cycle of the switching signal.

### BRIEF DESCRIPTION OF THE DRAWINGS

FIG. 1 illustrates a functional block diagram of a power conversion circuit according to an embodiment of the application.

FIG. 2 shows a functional block diagram of the controller according to an embodiment of the application.

FIG. 3 shows a flowchart of a power conversion circuit control method according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

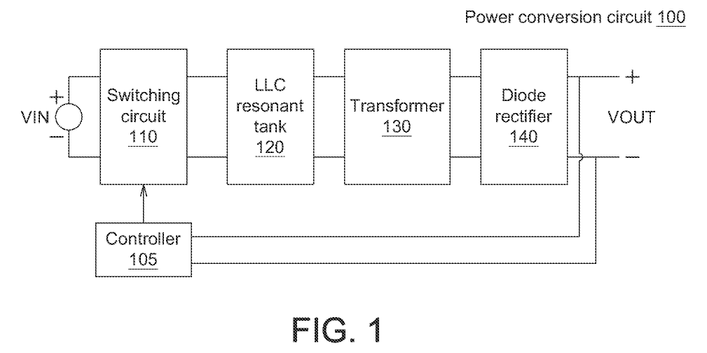

FIG. 1 illustrates a functional block diagram of a power conversion circuit according to an embodiment of the application. The power conversion circuit 100 in one embodiment includes a controller 105, a switching circuit 110, a LLC resonant tank 120, a transformer 130, and a diode rectifier 140.

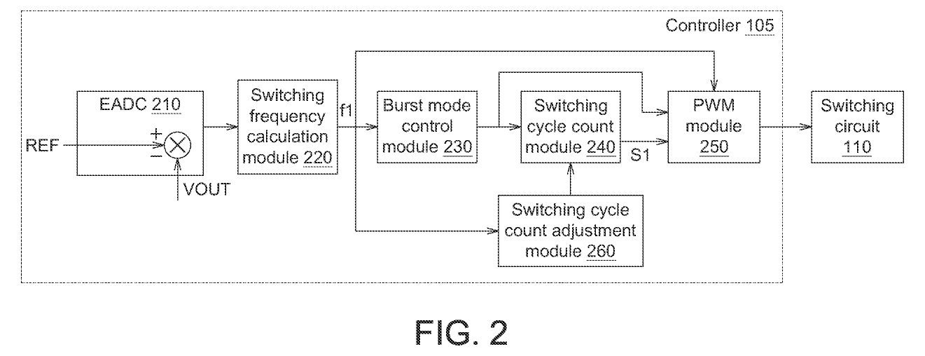

The controller 105 is coupled to the switching circuit 110. The controller 105 (and its internal modules, as shown in FIG. 2) can be implemented, for example, using a chip, a circuit block within a chip, a firmware circuit, or a circuit board containing several electronic components and wires, though this invention is not limited to these options.

The switching circuit 110 converts the input DC voltage VIN into a high-frequency square wave and can be implemented with a full-bridge or half-bridge topology. The controller 105 can generate a switching signal (such as but not limited to a pulse width modulation (PWM) signal) to control the on/off states of the internal switches in the switching circuit 110.

The LLC resonant tank 120 is coupled to the switching circuit 110. The high-frequency square wave generated by the switching circuit 110 enters the LLC resonant tank 120, which filters out high-frequency harmonics and outputs an alternating current (AC) wave with a fundamental frequency.

The transformer 130 is coupled to the LLC resonant tank 120. The AC wave generated by the LLC resonant tank 120 is transmitted through the transformer 130 to the secondary side of the transformer 130, where the voltage is stepped up or down according to application requirements.

The diode rectifier 140 is coupled to the transformer 130. The diode rectifier 140 converts the AC wave output from the transformer 130 into a stable output voltage VOUT, which is a DC output voltage. The diode rectifier 140 is also connected to the controller 105 to provide the output voltage VOUT to the controller 105.

FIG. 2 shows a functional block diagram of the controller 105 according to an embodiment of the application. In this embodiment, the controller 105 is, for example, but not limited to, a digital signal processor (DSP). The controller 105 includes an error analog-to-digital converter (EADC) 210, a switching frequency calculation module 220, a burst mode control module 230, a switching cycle count module 240, a pulse-width modulation (PWM) module 250, and a switching cycle count adjustment module 260.

The error analog-to-digital converter 210 compares a reference value REF (provided by a ramp module) with the output voltage VOUT to generate an error value for the switching frequency calculation module 220. The reference value REF can be a ramp voltage with a ramp waveform.

The switching frequency calculation module 220 is coupled to the error analog-to-digital converter 210. Based on the error value generated by the error analog-to-digital converter 210, the switching frequency calculation module 220 calculates a first frequency f1. In some embodiments, the switching frequency calculation module 220 may be an error proportional-integral computing module.

The burst mode control module 230 is coupled to the switching frequency calculation module 220 and the pulse-width modulation (PWM) module 250. When the first frequency f1 of the switching frequency calculation module 220 is higher than the burst mode threshold frequency, the burst mode control module 230 controls the PWM module 250 to keep the switching signal of the PWM module 250 always at logic low. When the first frequency f1 of the switching frequency calculation module 220 is lower than the burst mode threshold frequency, the burst mode control module 230 controls the PWM module 250 to output the switching signal normally. When the switching signal of the PWM module 250 is always at logic low, the internal switches of the switching circuit 110 do not switch (turn on and turn off). In response to a toggling waveform in the switching signal from the PWM module 250, the internal switches of the switching circuit 110 are triggered to operate.

The switching cycle count module 240 is coupled to the burst mode control module 230. Within a complete cycle, if the first frequency f1 of the switching frequency calculation module 220 is above the burst mode threshold frequency (which keeps the PWM module’s switching signal at logic low), the switching cycle count module 240 increments a cycle count by a predetermined cycle count (such as 1, but not limited to this value). For example, if the first frequency f1 of the switching frequency calculation module 220 exceeds the burst mode threshold frequency for three consecutive cycles (that is, during the three consecutive cycles, the switching signal of the PWM module 250 always at logic low), the switching cycle count module 240 adds 3 to the cycle count. When the cycle count reaches a predetermined cycle number (set by the switching cycle count module 240), the switching cycle count module 240 sends a command signal S1 to the PWM module 250. Upon receiving the command signal S1, the PWM module 250 outputs a single cycle of the switching signal having a frequency equal to the first frequency f1 of the switching frequency calculation module 220. After the PWM module 250 outputs a single cycle of the switching signal, the switching cycle count module 240 resets the cycle count. Alternatively, if the cycle count has not yet reached the predetermined cycle number and the first frequency f1 of the switching frequency calculation module 220 drops below the burst mode threshold frequency, the switching cycle count module 240 resets the cycle count.

The PWM module 250 is coupled to the switching frequency calculation module 220, the burst mode control module 230, and the switching cycle count module 240. Based on the first frequency f1 of the switching frequency calculation module 220, control of the burst mode control module 230, and the command signal S1 from the switching cycle count module 240, the PWM module 250 generates a switching signal at the corresponding frequency to the switching circuit 110, thereby controlling the on/off states of the internal switches of the switching circuit 110.

The switching cycle count adjustment module 260 is coupled to both the switching cycle count module 240 and the switching frequency calculation module 220. Based on the first frequency f1 of the switching frequency calculation module 220, the switching cycle count adjustment module 260 dynamically adjusts the predetermined cycle number of the switching cycle count module 240. For example, when the first frequency f1 of the switching frequency calculation module 220 is above a reference frequency (which is user-defined and higher than the burst mode threshold), the switching cycle count adjustment module 260 increases the predetermined cycle number (for example, but not limited to, the switching cycle count adjustment module 260 increases the predetermined cycle number by the predetermined cycle count (such as 1)). When the first frequency f1 of the switching frequency calculation module 220 is below the reference frequency, the switching cycle count adjustment module 260 decreases the predetermined cycle number (for example, but not limited to, the switching cycle count adjustment module 260 decreases the predetermined cycle number by the predetermined cycle count (such as 1)). The switching cycle count adjustment module 260 issues a fast interrupt to adjust (increase or decrease) the predetermined cycle number of the switching cycle count module 240.

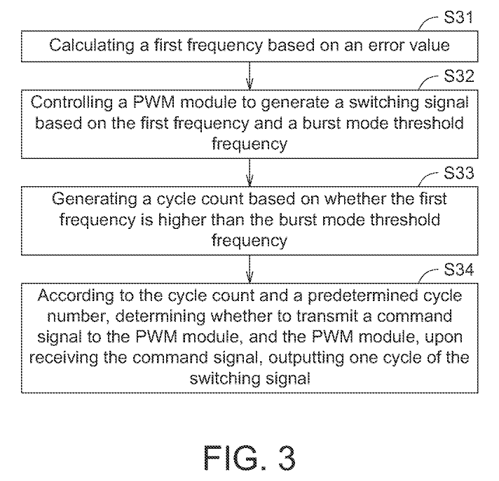

FIG. 3 shows a flowchart of a power conversion circuit control method according to one embodiment of the application. In step S31, a first frequency f1 is calculated based on an error value. In step S32, based on the first frequency f1 and the burst mode threshold frequency, a PWM module is controlled to generate a switching signal. In step S33, a cycle count is generated based on whether the first frequency f1 is higher than the burst mode threshold frequency. In step S34, based on the cycle count and a predetermined cycle number, it is determined whether to send a command signal S1 to the PWM module, and the PWM module outputs one cycle of the switching signal upon receiving the command signal S1.

In the aforementioned embodiments, the startup time of the output voltage VOUT of the power conversion circuit 100 can be extended, for example, from 2ms to 50ms, ensuring linearity in the soft-start process of the output voltage.

In these embodiments, the soft-start process effectively reduces inrush current (including output and resonant current), lowering stress on components.

The control method in these embodiments not only linearizes the reference value increase of the output voltage but also reduces the internal software logic execution time of the controller.

The control method in these embodiments does not add any additional hardware circuits to the controller (i.e., it can be implemented using a DSP hardware architecture), so it does not increase the hardware cost of the power conversion circuit or complicate PCB layout.

The solution provided in these embodiments has been primarily described from the perspective of power conversion circuit control. It is understood that the power conversion circuit and/or the power conversion controller may include corresponding hardware structures and/or software modules to achieve these functions. Professionals in the field can readily recognize that the embodiments described can be implemented in hardware or a combination of hardware and software. The choice between hardware and software implementation depends on specific application and design considerations.

In this embodiment, the power conversion circuit and/or power conversion controller can be divided into functional modules based on the aforementioned method. For example, each functional module can be divided according to its respective function, or two or more functions can be integrated into a single functional module. The integrated module can be implemented in hardware or as a software function module. It should be noted that in this embodiment, modular division is only an example for logical function division. Other methods of division may be used in practical implementations.

Although this description contains many specific details, they should not be interpreted as limitations on the invention’s scope, but rather as characteristics of specific implementations. Certain features described in the context of a single embodiment may also be implemented in combination within a single embodiment. Conversely, various features described in the context of a single embodiment may be implemented independently or in any suitable sub-combination across multiple embodiments. Although features may be initially described as functioning in certain combinations, it may be possible in some cases to omit one or more features from such a combination. Similarly, while operations are illustrated in a particular sequence, they are not required to follow the exact sequence or to include all depicted operations to achieve desired results.

The disclosed embodiments are merely examples. Based on the disclosed content, variations, modifications, and enhancements may be made to the described examples and implementations.

In summary, while the invention has been described through these embodiments, they are not intended to limit the invention. Those skilled in the art can make various modifications and enhancements without departing from the spirit and scope of the invention. Thus, the scope of the invention should be predetermined by the appended claims.

What is claimed is:

1. A power conversion circuit controller, comprising:
a switching frequency calculation module, calculating a first frequency based on an error value;
a pulse width modulation (PWM) module;
a burst mode control module, coupled to the switching frequency calculation module and the PWM module, wherein the burst mode control module controls the PWM module to generate a switching signal based on the first frequency and a burst mode threshold frequency; and
a switching cycle count module, coupled to the burst mode control module and the PWM module, wherein the switching cycle count module generates a cycle count based on whether the first frequency is higher than the burst mode threshold frequency, and according to the cycle count and a predetermined cycle number, the switching cycle count module determines whether to transmit a command signal to the PWM module, and the PWM module, upon receiving the command signal, outputs one cycle of the switching signal.

2. The power conversion circuit controller according to claim 1, wherein the switching frequency of the switching signal is the first frequency.

3. The power conversion circuit controller according to claim 1, further comprising:
an error analog-to-digital converter, coupled to the switching frequency calculation module, the error analog-to-digital converter comparing a reference value with an output voltage to generate the error value.

4. The power conversion circuit controller according to claim 3, wherein the reference value is a ramp voltage having a ramp waveform.

5. The power conversion circuit controller according to claim 1, further comprising:
a switching cycle count adjustment module, coupled to the switching cycle count module and the switching frequency calculation module, the switching cycle count adjustment module adjusting the predetermined cycle number based on the first frequency.

6. The power conversion circuit controller according to claim 5, wherein:
when the first frequency is higher than a reference frequency, the switching cycle count adjustment module increases the predetermined cycle number;
when the first frequency is lower than the reference frequency, the switching cycle count adjustment module decreases the predetermined cycle number; and
the reference frequency is higher than the burst mode threshold frequency.

7. The power conversion circuit controller according to claim 1, wherein:
when the first frequency is higher than the burst mode threshold frequency, the burst mode control module controls the PWM module so that the switching signal generated by the PWM module is continuously held at a logical low, and
when the first frequency is lower than the burst mode threshold frequency, the burst mode control module controls the PWM module so that the PWM module outputs the switching signal.

8. The power conversion circuit controller according to claim 1, wherein:
when, within one cycle, the first frequency is higher than the burst mode threshold frequency, the switching cycle count module increments the cycle count by a predetermined cycle count; and
when the cycle count equals the predetermined cycle number, the switching cycle count module transmits the command signal to the PWM module.

9. The power conversion circuit controller according to claim 8, wherein:
when the switching cycle count module transmits the command signal to the PWM module, the switching cycle count module resets the cycle count; and
in case that the cycle count is below the predetermined cycle number, when the first frequency is lower than the burst mode threshold frequency, the switching cycle count module resets the cycle count.

10. A power conversion circuit control method, comprising:
calculating a first frequency based on an error value;
controlling a pulse width modulation (PWM) module to generate a switching signal based on the first frequency and a burst mode threshold frequency;
generating a cycle count based on whether the first frequency is higher than the burst mode threshold frequency; and
according to the cycle count and a predetermined cycle number, determining whether to transmit a command signal to the PWM module, and the PWM module, upon receiving the command signal, outputting one cycle of the switching signal.

11. The power conversion circuit control method according to claim 10, wherein the switching frequency of the switching signal is the first frequency.

12. The power conversion circuit control method according to claim 10, further comprising:
comparing a reference value with an output voltage to generate the error value.

13. The power conversion circuit control method according to claim 12, wherein the reference value is a ramp voltage having a ramp waveform.

14. The power conversion circuit control method according to claim 10, further comprising:
adjusting the predetermined cycle number based on the first frequency.

15. The power conversion circuit control method according to claim 14, wherein:
when the first frequency is higher than a reference frequency, the predetermined cycle number is increased;
when the first frequency is lower than the reference frequency, the predetermined cycle number is decreased; and
the reference frequency is higher than the burst mode threshold frequency.

16. The power conversion circuit control method according to claim 10, wherein:
when the first frequency is higher than the burst mode threshold frequency, the PWM module is controlled to generate the switching signal continuously held at a logical low, and
when the first frequency is lower than the burst mode threshold frequency, the PWM module is controlled to output the switching signal.

17. The power conversion circuit control method according to claim 10, wherein:
when, within one cycle, the first frequency is higher than the burst mode threshold frequency, the cycle count is incremented by a predetermined cycle count; and
when the cycle count equals the predetermined cycle number, the command signal is transmitted to the PWM module.

18. The power conversion circuit control method according to claim 17, wherein:
when the command signal is transmitted to the PWM module, the cycle count is reset; and
in case that the cycle count is below the predetermined cycle number, when the first frequency is lower than the burst mode threshold frequency, the cycle count is reset.
